(19) United States
(12) Patent Application Publication
(10) Pub. No.: US 2015/0055537 A1
(43) Pub. Date: Feb. 26, 2015

(54) MEDIA ACCESS CONTROL (MAC) PROTOCOL WITH PATH OPERATORS FOR MULTIPATH WIRELESS NETWORKS

(71) Applicant: Sumsung Electronics Co., Ltd., Suwon (KR)

(72) Inventors: Huai-Rong Shao, San Jose, CA (US); Chiu Ngo, Millbrae, CA (US)

(73) Assignee: Sumsung Electronics Co., Ltd., Suwon (KR)

(21) Appl. No.: 14/010,426

(22) Filed: Aug. 26, 2013

(51) Int. Cl. H04L 12/707; H04W 40/02

(52) U.S. Cl. CPC H04L 45/24; H04W 40/02
USPC 370/312

(57) ABSTRACT

An embodiment of wireless communication comprises passing data from a higher layer to a communication layer via multiple data paths for parallel data communication in a wireless device, wherein passing the data comprises controlling passing of said data on the multiple data paths based on communication requirements using path operators. The wireless communication further comprises processing data as packet-less units of data on the multiple data paths, and transmitting the data from the multiple data paths on multiple wireless communication paths from the wireless device.

### TECHNICAL FIELD

One or more embodiments relate generally to wireless communication, and in particular, to high throughput wireless communication.

### BACKGROUND

Wireless communication devices are increasingly common and applications implemented on such devices increasingly request higher wireless transmission speeds. For example, Ultra High Definition (UHD) video format utilizes uncompressed video format, requiring 72 Gbps channel bandwidth with 36 bits/pixel color depth and 60 frame rate.

### SUMMARY

An embodiment of wireless communication comprises passing data from a higher layer to a communication layer via multiple data paths for parallel data communication in a wireless device, wherein passing the data comprises controlling passing of said data on the multiple data paths based on communication requirements using path operators. The wireless communication further comprises processing data as packet-less units of data on the multiple data paths, and transmitting the data from the multiple data paths on multiple wireless communication paths from the wireless device.

According to another embodiment, a computer program product for wireless communication comprises a tangible storage medium readable by a computer system and storing instructions for execution by the computer system for passing data from a higher layer to a communication layer via multiple data paths for parallel data communication in a wireless device, wherein passing the data comprises controlling passing of said data on the multiple data paths based on communication requirements using path operators. The wireless communication further comprises processing data as packet-less units of data on the multiple data paths, and transmitting the data from the multiple data paths on multiple wireless communication paths from the wireless device.

According to another embodiment, a wireless communication device comprises a multi-path MAC module for passing data from a higher layer to a communication layer via multiple data paths for parallel data communication in a wireless device, wherein passing the data comprises controlling passing of said data on the multiple data paths based on communication requirements using path operators. The wireless communication device further comprises a management control module for processing data as packet-less units of data on the multiple data paths, and a PHY communication module for transmitting the data from the multiple data paths on multiple wireless communication paths on wireless channels.

These and other features, aspects and advantages of the disclosed embodiments will become understood with reference to the following description, appended claims and accompanying figures.

### BRIEF DESCRIPTION OF THE DRAWINGS

FIG. 1A shows a block diagram of an example wireless communication network system, implementing a multi-path MAC protocol, according to one embodiment.

FIG. 1B illustrates multi-path transmission, according to one embodiment.

FIG. 2A illustrates architecture of a wireless device including functional layers implementing a multi-path MAC protocol, according to an embodiment.

FIG. 2B illustrates a process for multi-path communication, according to an embodiment.

FIG. 3 illustrates a multi-path MAC protocol for packet-less wireless transmission using a basic unit of data, according to an embodiment.

FIG. 4 illustrates another multi-path MAC protocol for packet-less wireless transmission using a basic unit of data, according to an embodiment.

FIG. 5 illustrates another multi-path MAC protocol for packet-less wireless transmission using a basic unit of data, according to an embodiment.

FIG. 6 illustrates another multi-path MAC protocol for packet-less wireless transmission using a basic unit of data, according to an embodiment.

FIG. 7 illustrates another multi-path MAC protocol for packet-less wireless transmission using a basic unit of data, according to an embodiment.

FIG. 8 shows a flowchart of a multi-path MAC protocol, according to an embodiment.

FIG. 9 shows an example network in which wireless devices 451 implementing multi-path MAC protocols, according to an embodiment.

FIG. 10 is a high level block diagram showing an information processing system comprising a computer system useful for implementing an embodiment.

### DETAILED DESCRIPTION

One or more embodiments relate to a media access control (MAC) protocol for ultra high throughput wireless networks including wireless devices, are disclosed. According to one embodiment, the MAC protocol comprises a multi-path MAC protocol providing content-aware fluid-based parallel MAC processing and content-aware operators for ultra high throughput (UHT) wireless networks.

According to one embodiment, a method of wireless communication comprises establishing multiple data paths for parallel data communication in a wireless device, processing data as packet-less units of data on the multiple data paths, and transmitting the data from the multiple data paths on multiple wireless communication paths from the wireless device.

According to one embodiment, a parallel MAC processing protocol utilizes capacities at different communication paths between wireless devices for wireless communication. The parallel MAC processing protocol provides flexible transmission schemes utilizing different operators, described hereinbelow.

In one embodiment, a wireless device comprises a wireless station for communication with other communication stations over a communication link (communication medium). In one implementation, a wireless device includes a processor, memory, logic, transceiver and communication layers such as a network layer, a MAC layer, a PHY layer. The communication can include broadcast communication and directional communication. Examples of applicable wireless communication include Wi-Fi, WiGig, LTE, mmWave wireless communication, 60 GHz band and higher, 5 GHz band, ultra high throughput (UHT), multi-Gbps (gigabits per second), etc.

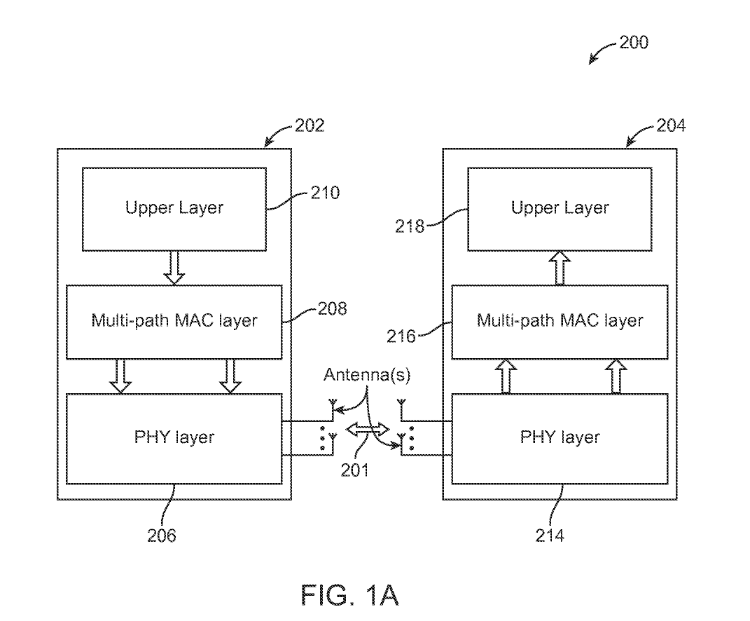

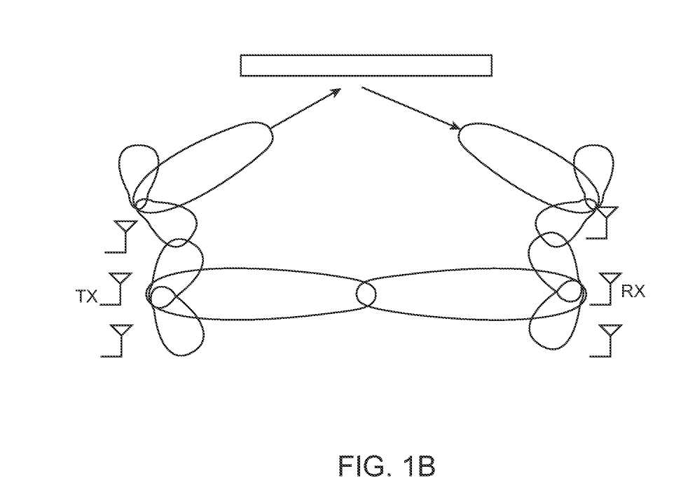

FIG. 1A shows a block diagram of an example wireless communication network system 200, implementing a multi-path MAC protocol. The system 200 includes a wireless device 202 and a wireless device 204. The wireless devices 202 and 204 communicate via a wireless communication link 201.

The wireless device 202 includes a PHY layer 206, a multi-path MAC layer 208 implementing a multi-path MAC protocol, and an upper layer 210. The PHY layer 206 comprises a communication module for transmitting/receiving signals via a communication link 201. In one example, the upper layer 210 implements an application layer that sources/sinks information which is processed by the multi-path MAC layer 208.

The wireless device 204 includes a PHY layer 214, a multi-path MAC layer 216 implementing a multi-path MAC protocol, and an upper layer 218. The PHY layer 214 comprises a communication module which transmits/receives signals via the communication link 201. The upper layer 218 implements an application layer that sources/sinks information which is processed by the multi-path MAC layer 216.

An embodiment of the multi-path MAC protocol utilizes multi-path antenna capabilities at the PHY layer in a wireless device, wherein said multi-path MAC protocol in the wireless device provides coordination of multiple paths between an application layer the PHY later to meet various application requirements.

In one embodiment, said multi-path MAC protocol comprises a parallel MAC processing protocol that provides content-aware fluid-based parallel MAC processing, enabling a higher application layer to access the PHY layer directly via multiple data paths and utilize multiple PHY communication paths. Utilizing the parallel architecture, said application layer can pass data to the PHY layer quickly, wherein the PHY layer transmits the data on multiple wireless paths simultaneously. In one implementation, content-aware means that the lower layers (MAC and PHY) have information (e.g., tag or metadata) about the data traffic at higher layers, and function accordingly

As illustrated by example in FIG. 1B, multi-path transmission means that between a two wireless devices, such as wireless transmitter (TX) and a wireless receiver (RX), communication over radio frequency (RF) channels, there are multiple separated paths for the same application layer. There are several multi-path antenna approaches in 60 GHz wireless communication, such as, polarized antenna, Multiple-Input Multiple-Output (MIMO), Multi-beam Antenna Array, multiple sectored antenna, etc.

These multi-path antenna approaches can have different characteristics. For example, in the polarized antenna case, horizontal polarization (H) and vertical polarization (V) antennas can be treated as completely independent. Specifically, one antenna can be set in the receiving mode while the other antenna can be set in the sending mode. However, in the multi-beam antenna array case, all beams need to be set to the same either receiving or sending mode.

Channel bonding is a known approach to improve throughput by combining multiple channels for data transmission. For example, in IEEE 802.11ac, two 80 MHz channels can be combined together. Channel bonding can be combined with multiple above-mentioned antenna approaches.

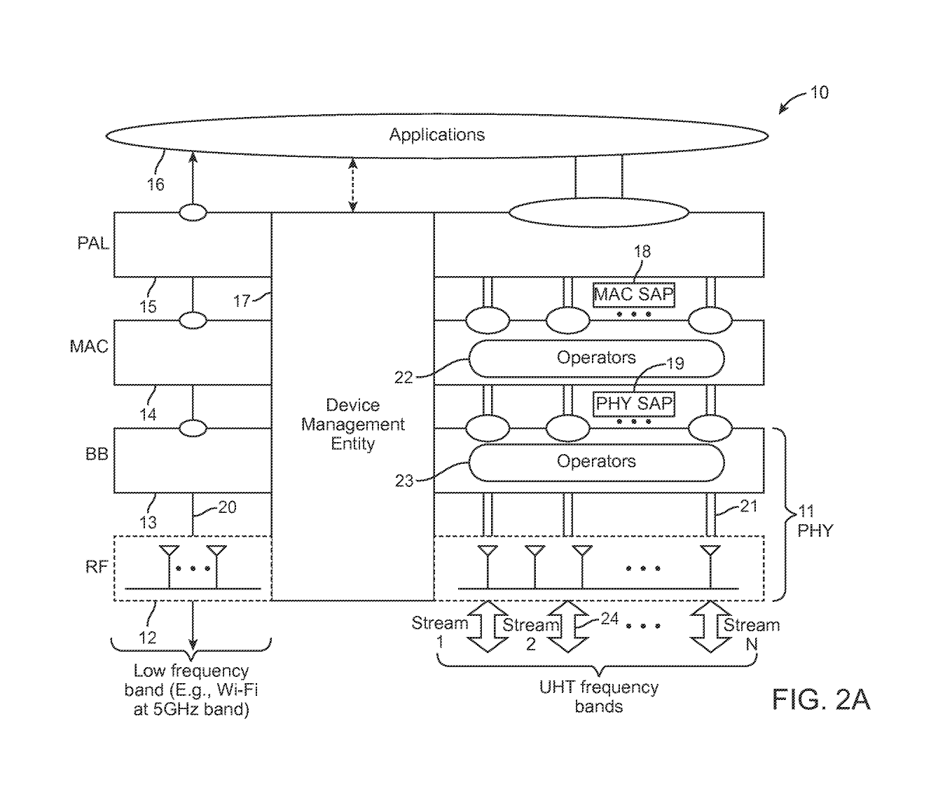

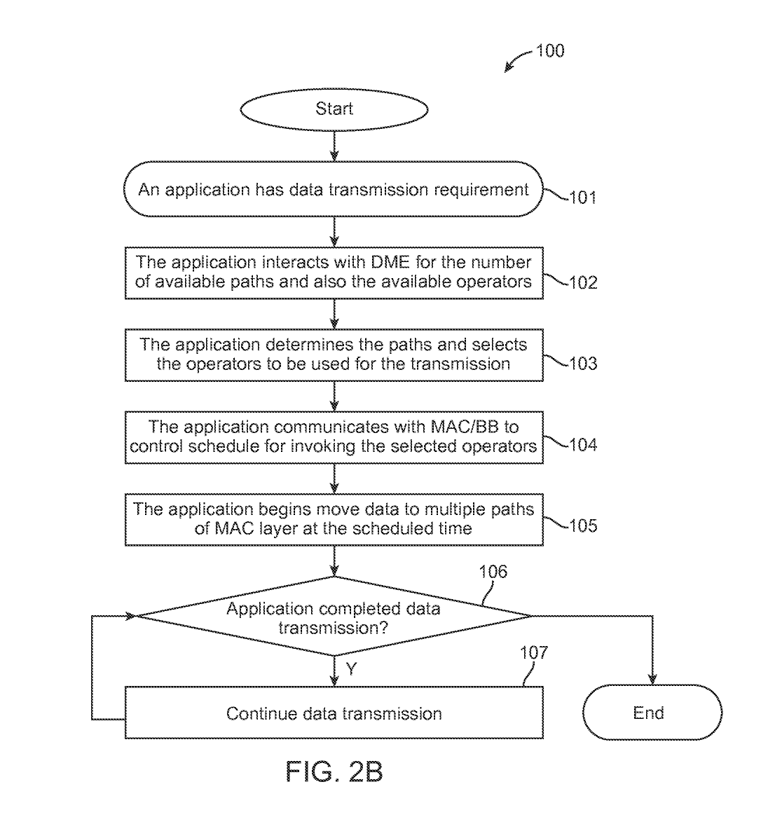

FIG. 2A illustrates architecture of an example wireless device 10 (such as a wireless transceiver device 202), including functional layers (entities or modules) implementing said multi-path MAC protocol for coordinating multiple paths. The functional layers include: a physical (PHY) layer 11 comprising an RF layer 12 and Baseband (BB) layer 13, a MAC layer 14, a protocol adaptation layer (PAL) 15, and a device management entity (DME) 17.

Further, a MAC SAP function 18 provides MAC layer Service Access Point, and a PHY SAP function 19 provides PHY layer Service Access Point. The MAC layer 14 includes content-aware operators 22, and the BB layer 13 includes content-aware operators 23, as described further below. The baseband layer allows communicating control information and other information. The RF layer enables transmitting/receiving signals under control of a baseband layer. In one example, at the transmitter the PAL layer may include an audio/visual (A/V) pre-processing function and an AV/C control layer which sends transmission requests and control commands to reserve channel time blocks communication. In one example, at the receiver the PAL layer performs reverse operation of the transmitter PAL layer, and handles stream control and channel access.

In one embodiment, the parallel MAC processing protocol employs low frequency band wireless communication (e.g., Wi-Fi at 5 GHz band) for certain control and management such as device discovery and capability exchange, beam training feedback, beam recovery, and UHT channel reservation. The parallel MAC processing protocol employs high frequency band wireless communication 21 (e.g., 60 GHz and higher) for high-speed data transmission as well as control and management message exchange.

The DME 17 allows set up of appropriate configurations based on the configuration at other layers. The DME 17 further allows coordination between low frequency band (e.g., Wi-Fi at 5 GHz) and UHT band. The DME 17 crosses multiple layers and enables the layers to set appropriate configuration based on the configuration on other layers. The DME 17 also enables the coordination between Wi-Fi band and UHT band. For example, an application can directly determine from the DME how many parallel paths a PHY layer can provide and then control the DME to configure the paths for data transmission by the application layer via those paths.

As described in more detail below, the multi-path MAC protocol implemented by said function layers illustrated in FIG. 2A, enables higher level applications layer 16 to access the PHY layer 11 directly via multiple data paths 21 and utilize multiple PHY wireless communication paths 24 (e.g., Stream 1, Stream 2, . . . , Stream N) for high speed data communication over wireless links.

FIG. 2B illustrates a process 100 for multi-path communication, according to an embodiment. In process block 101, an upper layer application has data transmission requirement. In process block 102, the application interacts with the DME layer for the number of available paths and also the available content-aware operators. In one implementation, the content-aware operators comprise parallel operators that provide flexible content-aware parallel operations to control the data passing on multiple paths between the layers to fulfill application layer requests, and also adapt to dynamic wireless communication link conditions at different PHY wireless paths.

In process block 103, the application determines the number of paths to use and selects the operators to be used, for the transmission. The application selects the number of paths and the type of operators that provide efficiency in resource utilization and data transfer.

In process block 104, the application communicates with MAC and/or BB layers to control a schedule for invoking the selected operators. In process block 105, the application begins moving data to multiple paths of MAC layer at the scheduled time, as determined above. According to process blocks 106 and 107, data transmission on the multiple paths utilizing the selected operators continues until the application data transmission requirements have been satisfied.

### UHT Content-Aware Fluid-Based Parallel MAC Processing

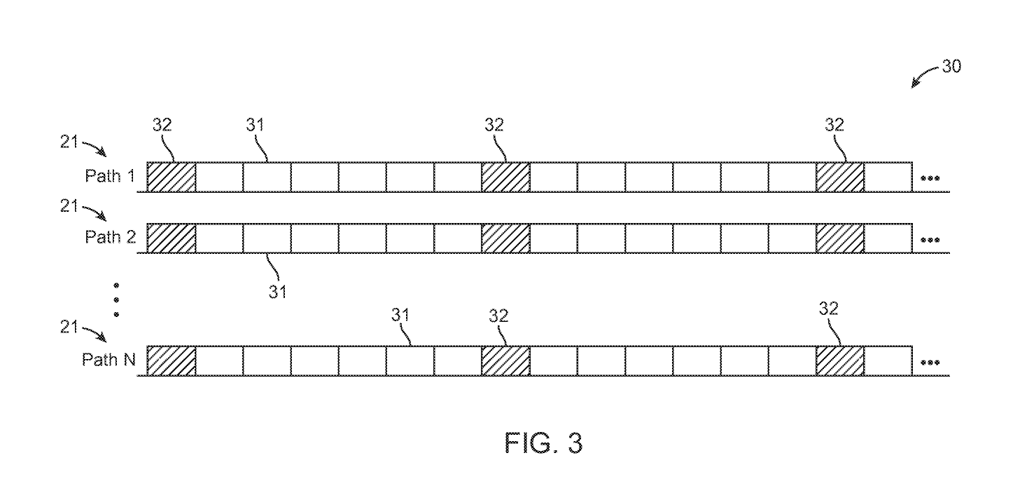

Referring to FIG. 3, in one embodiment, the multi-path MAC protocol provides packet-less wireless transmission 30 using a basic unit of data 31 called a fluid particle herein. The fluid particle 31 is scalable and can be any one of, for example, a bit, a byte, a PHY symbol and a data packet which has multiple bytes and symbols. The multi-path MAC protocol provides synchronous low latency fluid-based transmission utilizing said fluid particle 31 on multiple paths 21 (e.g., Path 1, Path 2, . . . , Path N).

Each fluid particle 31 at a UHT channel has a fixed size in time duration. The actual fluid particle size in bits can vary on different paths. With fixed fluid particle size in time duration, both wireless transmitter and receiver devices can easily perform MAC processing and synchronization.

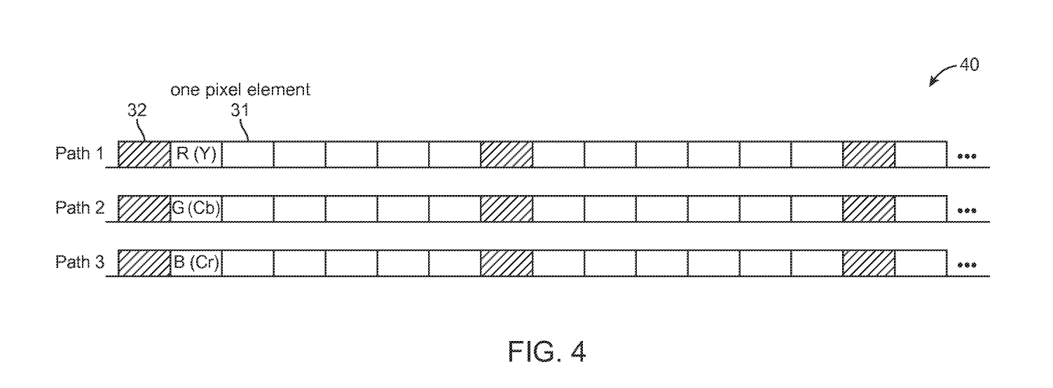

The size of the fluid particle 31 can be determined based on application layer requirements and wireless communication link capacity at each PHY path 24 (FIG. 2A). As an example packet-less wireless transmission 40 shown in FIG. 4 according to the multi-path MAC protocol, there are three paths (e.g., Path 1, Path 2, Path 3) for video transmission and the fluid particle 31 at each path can be a pixel element R, G, B or Y, Cb, Cr.

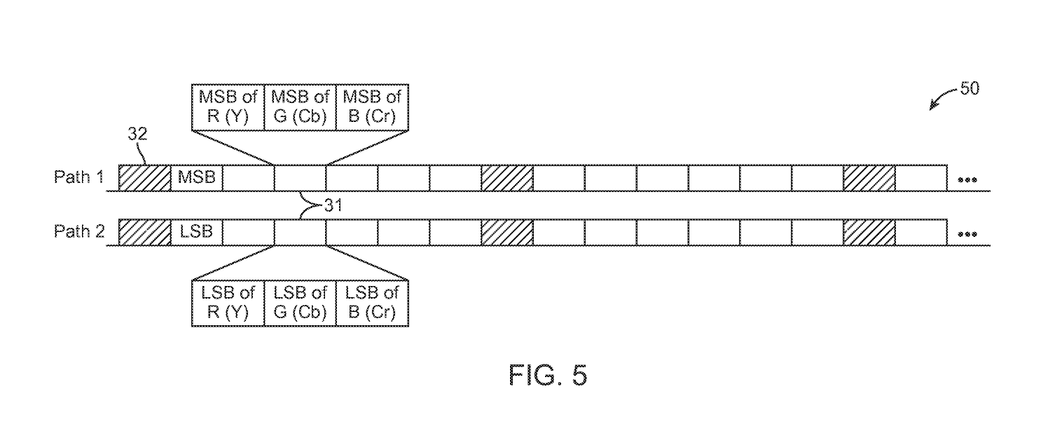

As another example packet-less wireless transmission 50 shown in FIG. 5 according to the multi-path MAC protocol, there are two paths (e.g., Path 1, Path 2) and the MSB (most significant bits) and LSB (least significant bits) of pixels are separated into fluid particles 31 accordingly. As such, fluid particles 31 on Path 1 include MSB information and fluid particles 31 on Path 2 include LSB information.

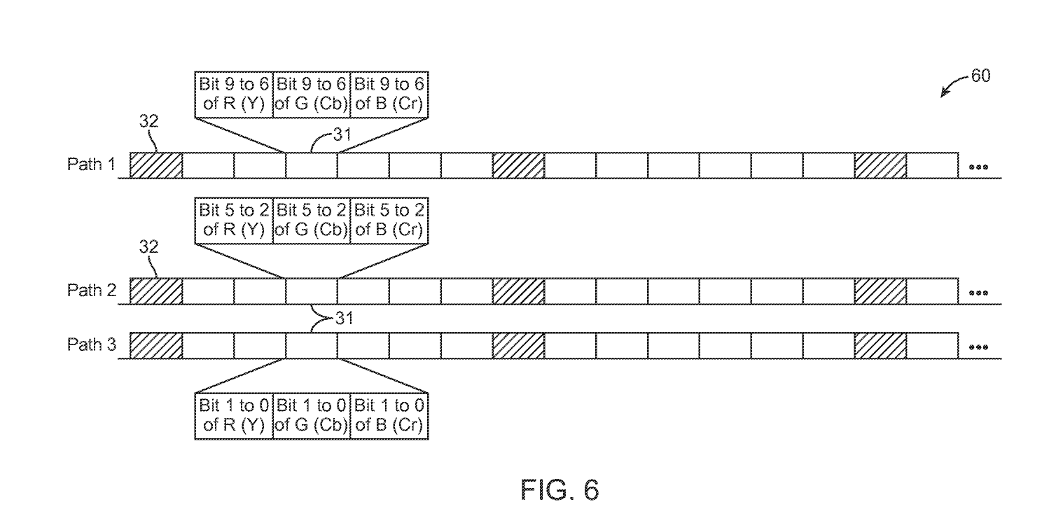

As another example packet-less wireless transmission 60 shown in FIG. 6 according to the multi-path MAC protocol, there are three paths (e.g., Path 1, Path 2, Path 3) and Path 3 has half data rate of Path 1 and Path 2, and for 30 bits R, G, B or Y, Cb, Cr uncompressed video. The bits 9 to 6 of pixels are carried in fluid particles 31 on Path 1, the bits 5 to 2 of pixels are carried in fluid particles 31 on Path 2, and the bits 1 to 0 of pixels are carried in fluid particles 31 on Path 3. Generally, each fluid particle 31 can carry one or multiple pixels, such as shown by example in FIG. 6.

In one embodiment, as shown in FIG. 3, the multi-path MAC protocol utilizes a fixed length synchronization header 32 in both actual bit length and time duration to replace variable length MAC headers, thereby reducing typical header parsing overhead. The synchronization header 32 is periodically inserted into a path for the transmitter and receiver to keep synchronization on data transmission. The frequency of insertion of a synchronization header 32 depends on the wireless channel status. For example, when the channel is good and Bit error rate is very low (e.g., less than 10⁻¹²), the synchronization header can be inserted at the time scale of a second.

In one embodiment, the synchronization header 32 may also include control information for subsequent fluid particles 31 but before a next synchronization header 32.

In one embodiment, an option allows the transmitter or receiver to skip reading/writing unchanged fields (or all fields) in a synchronization header 32. Out-of-band control channel (e.g., Wi-Fi at 5 GHz band) may be used to exchange fluid particle format configuration change between the transmitter and the receiver.

According to an embodiment of the multi-path MAC protocol, use of a Short Interframe Space (SIFS) time can be avoided. One example involves dispensing with an ACK policy for uncompressed video transmission. This is because re-transmission cannot improve video quality greatly as the bit error ration (BER) is very low in beamforming transmission. Though the receiver may still check cyclic redundancy check (CRC) periodically, the CRC check result is only useful for wireless link monitoring when no other link monitoring processes such as signal to noise ratio (SNR) monitoring are implemented at PHY layer. The link monitoring information can be fed back to the transmitter via an out-of-band control channel.

With a No ACK policy, the SIFS can be removed completely using said multi-path MAC protocol, such as shown by example in FIG. 3. Each fluid flow will only proceed in one direction and will not be switched between transmitting and receiving states, thereby reducing MAC processing overheads.

According to an embodiment of the multi-path MAC protocol, for certain applications such as data file transfer which require no data loss, a dedicated two-way re-transmission channel can be used for ACK and re-transmission. In the two-way re-transmission channel SIFS is used. In this case, the two-way re-transmission channel is similar to a packet-based wireless channel and does not utilize a fluid-based approach.

### Content-Aware Parallel Operators

In one embodiment, the parallel MAC processing protocol provides content-aware parallel operators to coordinate multiple paths. In one implementation, the operators provide flexible content-aware parallel operations to control the data passing on multiple paths between said layers to fulfill application layer requests, and also adapt to dynamic wireless communication link conditions at different PHY wireless paths.

The content-aware parallel operators in MAC and PHY layers have information (e.g., tag or metadata) about the data traffic at higher layers, and function accordingly. The operators quicken the coordination of data processing between data paths 21 and at different functional layers in FIG. 2A. The operators provide parallel processing operations, as described further below.

In one embodiment, the set of content-aware parallel operators includes multiple independent functions to control data on multiple paths is said multi-path MAC protocol. Each function is called an operator herein. Different operators can be combined together to achieve function combinations.

As shown by example in FIG. 2A sets 22 and 23 at the PHY and MAC layers, respectively, are implemented for controlling the data passed on multiple paths between layers to fulfill application layer requirements and also adapt to the dynamic wireless link conditions at different PHY paths 24. The DME 17 can select which operators to be used at which functional layers to improve (and optimize) performance based on the application layer requirements. A single operator or combination of multiple operators can be used. For example, an operator matrix can be applied on the data when the data is passed along data paths 21 from application layer 16 to the PHY layer 11.

Said operators are content-aware to maximize the quality of service as well as improve MAC processing speed. For example, for 3D video communication, given the left eye view or right eye view of the 3D video, a synchronized fluid particle shuffling operator (as explained below) is aware of 3D video content and can function accordingly. Examples of content-aware operators according to embodiments of the multi-path MAC protocol are provided below. Each operator can be implemented at either MAC layer or PHY layer, or both, depending on implementation.

A repetition operator repeats the same copy of a data fluid particle at multiple paths. The repetition operator improves transmission reliability by transmitting the same data at different paths. For example, beacons can use this operate to improve transmission reliability or cover different directions. Multicasting can also use this operator.

An independently parallel passing operator that enables data streams at multiple paths that are completely independent of each other. There is no coordination between paths. For example, two independent applications in the application layer can use this operator to transmit their data on two paths independently.

A synchronized parallel passing operator enables data streams at multiple paths that are completely synchronized at fluid particle level. For example, multiple pixel partition sub-streams of video application can use this operator to transmit on multiple paths.

A synchronized fluid particle shuffling operator enables data streams at multiple paths that are shuffled on different paths periodically. For example, left view and right view streams of a 3D video application can use this operator to transmit fluid particles alternatively on two paths as shown in Table 1 below. This operator helps maintain the same quality of multiple data streams.

TABLE 1
Example schedule for multi-path transmission

| | Fluid particle number | | | | |
|---|---|---|---|---|---|
| | 1 | 2 | 3 | 4 | . . . |
| At path 1 | Stream 1 | Stream 2 | Stream 1 | Stream 2 | . . . |
| At path 2 | Stream 2 | Stream 1 | Stream 2 | Stream 1 | . . . |

A synchronized multiplexing operator enables multiple data streams that are multiplexed in a synchronized way onto one path. For example, left view and right view streams of a 3D video application can use this operator to transmit fluid particles in an interlaced way on one path if only one path is available.

A quality priority mapping operator enables multiple data streams with different quality requirement that are accordingly mapped to multiple paths with different link qualities. For example, MSBs of a video can be mapped to the more robust path and LSBs to the less robust path.

A stream filtering operator allows dropping one or more data streams can too adapt to the path link conditions.

A TX/RX concurrence operator enables paths that can be in receiving mode and other paths in the sending mode, at the same time. This operator can be used for applications that need two way data communications.

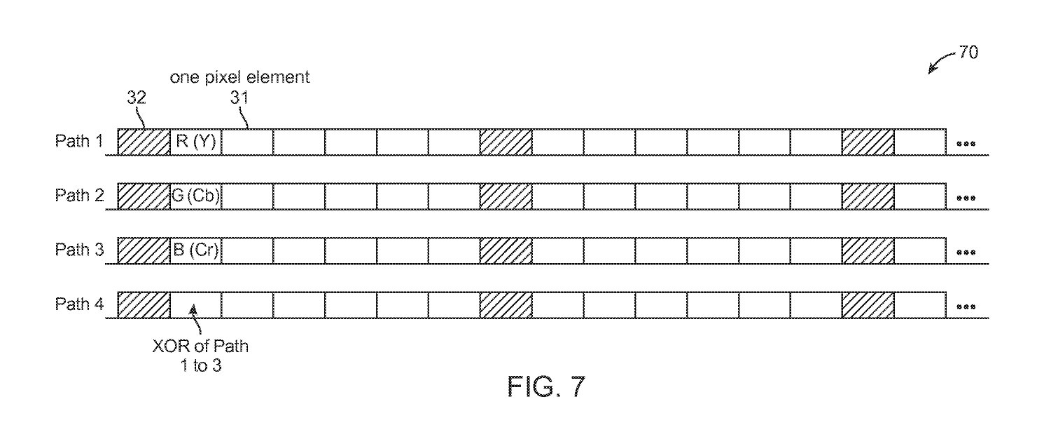

A parallel forward error correction (FEC) operator allows adding FEC information at an additional path to provide protection for data transmission on other paths. The parallel FEC is different from a sequential FEC. FIG. 7 illustrates a packet-less wireless transmission 70 with an example parallel FEC operation, wherein the results of an exclusive OR (XOR) operation for Path 1 to Path 3 can be transmitted at Path 4 from the transmitter. At the receiver side, the information received at Path 4 can be used to detect and correct bit errors. FIG. 7 illustrates an example wherein a pixel element is one fluid particle 31. A fluid particle can also carry an element of multiple pixels.

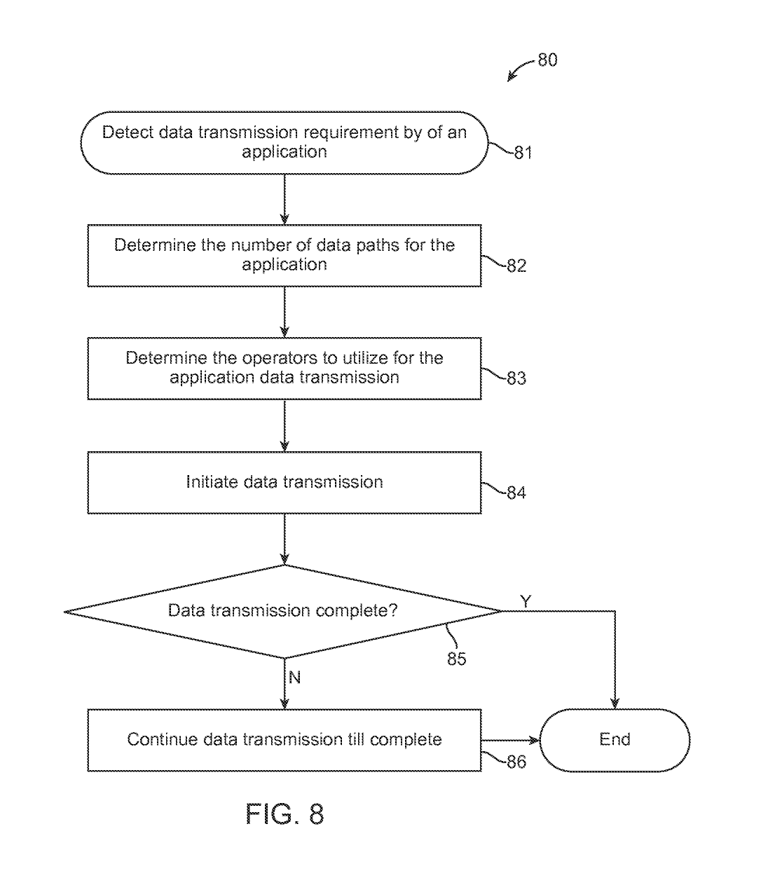

FIG. 8 shows a flowchart of an embodiment of a multi-path MAC protocol 80, wherein:

Process block 81 comprises detecting data transmission requirement by of an application.

Process block 82 comprises determining the number of data paths for the application.

Process block 83 comprises determining the operators to utilize for the application data transmission.

Process block 84 comprises initiating data transmission.

Process block 85 comprises determining if data transmission is complete.

Process block 86 comprises continuing data transmission till complete.

One or more embodiments disclosed herein enable MAC processing efficiency, such as several times the speed of conventional wireless systems. Further, MAC overhead is at least 20% lower than conventional wireless systems.

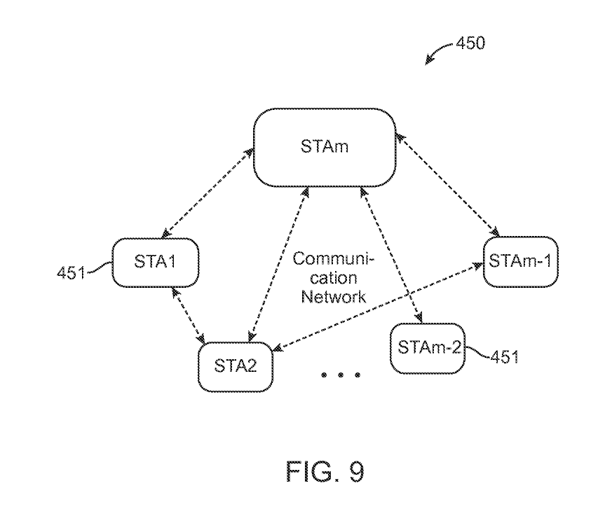

FIG. 9 shows an example network 450 of m wireless devices 451 (e.g., wireless devices 202, 204 in FIG. 1A), implementing multi-path MAC protocols. The devices 451 communicate over a wireless communication medium.

As is known to those skilled in the art, the aforementioned embodiments described above, can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters, receivers, transceivers in wireless networks, etc. Further, embodiments can take the form of an entirely hardware embodiment, an entirely software embodiment or an embodiment containing both hardware and software elements.

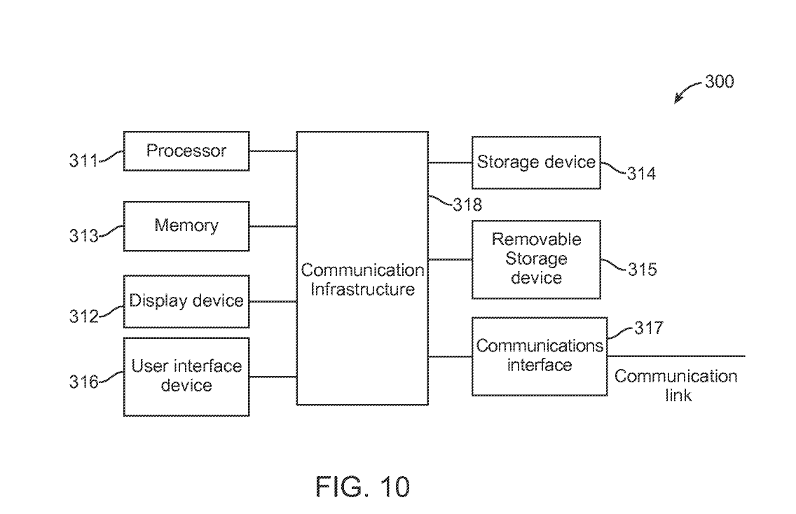

FIG. 10 is a high level block diagram showing an information processing system comprising a computer system 300 useful for implementing an embodiment of the multi-path MAC protocol. The computer system 300 includes one or more processors 311, and can further include an electronic display device 312 (for displaying graphics, text, and other data), a main memory 313 (e.g., random access memory (RAM)), storage device 314 (e.g., hard disk drive), removable storage device 315 (e.g., removable storage drive, removable memory module, a magnetic tape drive, optical disk drive, computer readable medium having stored therein computer software and/or data), user interface device 316 (e.g., keyboard, touch screen, keypad, pointing device), and a communication interface 317 (e.g., modem, a network interface (such as an Ethernet card), a communications port, or a PCMCIA slot and card). The communication interface 317 allows software and data to be transferred between the computer system and external devices. The system 300 further includes a communications infrastructure 318 (e.g., a communications bus, cross-over bar, or network) to which the aforementioned devices/modules 311 through 317 are connected.

Information transferred via communications interface 317 may be in the form of signals such as electronic, electromagnetic, optical, or other signals capable of being received by communications interface 317, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Example embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

Though the embodiments been described with reference to certain versions thereof; however, other versions are possible. Therefore, the spirit and scope of the appended claims should not be limited to the description of the preferred versions contained herein.

What is claimed is:

1. A method of wireless communication, comprising:
passing data from a higher layer to a communication layer via multiple data paths for parallel data communication in a wireless device, wherein passing the data comprises controlling passing of said data on the multiple data paths based on communication requirements using path operators;
processing data as packet-less units of data on the multiple data paths; and
transmitting the data from the multiple data paths on multiple wireless communication paths from the wireless device.

2. The method of claim 1, further comprising:
controlling passing of said data on the multiple data paths based on requirements of the higher layer.

3. The method of claim 1, further comprising:
controlling passing of said data on the multiple data paths based on communication link conditions at said different wireless communication paths.

4. The method of claim 1, further comprising:
establishing said multiple data paths from the higher layer to a physical (PHY) communication layer of the wireless device;
wherein controlling passing of said data from the higher layer to the communication layer comprises simultaneously passing data from the higher layer to a PHY layer via the multiple parallel data paths.

5. The method of claim 4, wherein:
controlling passing data from the higher layer to the PHY layer comprises simultaneously passing data from the higher layer to the PHY layer via the multiple parallel data paths in a multi-path medium access control (MAC) layer.

6. The method of claim 5, wherein:
controlling processing of said data on the multiple data paths further comprises utilizing one or more parallel operators to control passing of data on the multiple data paths between the layers based on the communication requirements.

7. The method of claim 6, wherein:
at least one of the parallel operators utilizes information about the data traffic at higher layers for controlling passing of data on the multiple data paths.

8. The method of claim 7, wherein:
at least one of the parallel operators coordinates data processing on the multiple data paths between layers based on the communication requirements.

9. The method of claim 6, further comprising:
selecting one or more parallel operators to coordinate parallel data processing on the multiple data paths based on high layer requirements.

10. The method of claim 6, further comprising:
selecting one or more parallel operators to coordinate parallel data passing on the multiple data paths based on high layer requirements.

11. A computer program product for wireless communication, the computer program product comprising:
a tangible storage medium readable by a computer system and storing instructions for execution by the computer system for performing a method comprising:
passing data from a higher layer to a communication layer via multiple data paths for parallel data communication in a wireless device, wherein passing the data comprises controlling passing of said data on the multiple data paths based on communication requirements using path operators;
processing data as packet-less units of data on the multiple data paths; and
transmitting the data from the multiple data paths on multiple wireless communication paths from the wireless device.

12. The computer program product of claim 11, further comprising:
controlling passing of said data on the multiple data paths based on requirements of the higher layer.

13. The computer program product of claim 11, further comprising:
controlling passing of said data on the multiple data paths based on communication link conditions at said different wireless communication paths.

14. The computer program product of claim 11, further comprising:
establishing said multiple data paths from the higher layer to a physical (PHY) communication layer of the wireless device;
wherein controlling passing of said data from the higher layer to the communication layer comprises simultaneously passing data from the higher layer to a PHY layer via the multiple parallel data paths.

15. The computer program product of claim 14, wherein:
controlling passing data from the higher layer to the PHY layer comprises simultaneously passing data from the higher layer to the PHY layer via the multiple parallel data paths in a multi-path medium access control (MAC) layer.

16. The computer program product of claim 15, wherein:
controlling processing of said data on the multiple data paths further comprises utilizing one or more operators to control passing of data on the multiple data paths between the layers based on the communication requirements.

17. The computer program product of claim 16, wherein:
at least one of the operators utilizes information about the data traffic at higher layers for controlling passing of data on the multiple data paths.

18. The computer program product of claim 17, wherein:
at least one of the operators coordinates data processing on the multiple data paths between layers based on the communication requirements.

19. The computer program product of claim 16, further comprising:
selecting one or more operators to coordinate parallel data processing on the multiple data paths based on high layer requirements.

20. The computer program product of claim 16, further comprising:
selecting one or more operators to coordinate parallel data passing on the multiple data paths based on high layer requirements.

21. The computer program product of claim 16, wherein:
said one or more operators comprise functions to control the data on multiple data paths and/or multiple communication paths, said one or more operators including one or more of:
a repetition operator that repeats the same copy of a data at multiple paths;
an independently parallel passing operator that enables data streams at multiple paths that are completely independent of each other;
a synchronized parallel passing operator that enables data streams at multiple paths that are completely synchronized at data unit level;
a synchronized data shuffling operator that enables data streams at multiple paths to be shuffled on different paths periodically;
a synchronized multiplexing operator that enables multiplexing multiple data streams onto one path;
a quality priority mapping operator that enables mapping multiple data streams with different quality requirements to multiple paths with different communication link qualities;
a stream filtering operator that enables dropping one or more data streams to adapt to the path link conditions;
a TX/RX concurrence operator that enables paths that can be in receiving mode and other paths in sending mode, at the same time; and
a parallel forward error correction (FEC) operator that enables adding FEC information at an additional path to provide protection for data transmission on other paths.

22. A wireless communication device, comprising:
a multi-path MAC module for passing data from a higher layer to a communication layer via multiple data paths for parallel data communication in a wireless device, wherein passing the data comprises controlling passing of said data on the multiple data paths based on communication requirements using path operators;
a management control module for processing data as packet-less units of data on the multiple data paths; and
a PHY communication module for transmitting the data from the multiple data paths on multiple wireless communication paths on wireless channels.

23. The wireless communication device of claim 22, wherein:
the management control module simultaneously passes data from the higher layer to the PHY communication module via the multiple parallel data paths; and
the multi-path MAC module controls simultaneously passing of said data on the multiple data paths based on requirements of the higher layer and/or communication link conditions at said different wireless communication paths.

24. The wireless communication device of claim 22, wherein:
the multi-path MAC module comprises one or more parallel operators to control passing of data on the multiple data paths between the layers based on the communication requirements, utilizing information about the data traffic at higher layers for controlling passing of data on the multiple data paths.

25. The method of claim 7, wherein:
said one or more operators comprise functions to control the data on multiple data paths and/or multiple communication paths, said one or more operators including one or more of:
a repetition operator that repeats the same copy of a data at multiple paths;
an independently parallel passing operator that enables data streams at multiple paths that are completely independent of each other;
a synchronized parallel passing operator that enables data streams at multiple paths that are completely synchronized at data unit level;
a synchronized data shuffling operator that enables data streams at multiple paths to be shuffled on different paths periodically;
a synchronized multiplexing operator that enables multiplexing multiple data streams onto one path;
a quality priority mapping operator that enables mapping multiple data streams with different quality requirements to multiple paths with different communication link qualities;
a stream filtering operator that enables dropping one or more data streams to adapt to the path link conditions;
a TX/RX concurrence operator that enables paths that can be in receiving mode and other paths in sending mode, at the same time; and
a parallel forward error correction (FEC) operator that enables adding FEC information at an additional path to provide protection for data transmission on other paths.
